(19) United States
(12) Patent Application Publication
(10) Pub. No.: US 2023/0236376 A1
(43) Pub. Date: Jul. 27, 2023

(54) NETWORK INTERFACE DEVICE BRACKET

(71) Applicant: CenturyLink Intellectual Property LLC, Broomfield, CO (US)

(72) Inventors: William Keaton, Yardley, PA (US); Brian Edward Bond, Fairmont, WV (US); Douglas Collins, Exton, PA (US); David Moore, Lakewood Ranch, FL (US)

(73) Assignee: CenturyLink Intellectual Property LLC, Broomfield, CO (US)

(21) Appl. No.: 18/053,130

(22) Filed: Nov. 7, 2022

Related U.S. Application Data
(60) Provisional application No. 63/266,992, filed on Jan. 21, 2022.

(51) Int. Cl. G02B 6/44; G02B 6/42

(52) U.S. Cl. CPC G02B 6/4446; G02B 6/4284

(57) ABSTRACT

A network interface device bracket and a method of connecting a network device to a network via the network interface device bracket is provided. According to an example, the network interface device bracket may be adapted to be removably attached to the network interface device and removably mounted to a mounting surface. The network interface device bracket may include an internal housing that is adapted to connect a jumper cable connected to the network interface device to a drop cable connected to a service provider network and to store excess drop cable.

### CROSS-REFERENCE TO RELATED APPLICATIONS

This application claims the benefit of U.S. Provisional Application No. 63/266,992 filed Jan. 21, 2022, entitled “Network Interface Device Bracket,” which is incorporated herein by reference in its entirety.

### BACKGROUND

As people become increasingly reliant on broadband network services, fiber-optic network connectivity, which can carry data at high speeds over long distances, is increasingly being extended to terminate at customers' premises. Fiber to the Premises (FTTP) is a form of fiber-optic communication delivery, in which an optical fiber is run in an optical distribution network from a service provider head office all the way to the premises occupied by the subscriber. In some examples, a transition box may be used on the exterior of the premises to run a drop cable to a network interface device that may be located interior to the premises. In some cases, the drop cable may be pre-connectorized and may be provided at pre-measured lengths, which, may be longer than needed between the location of the transition box and the network interface device.

### SUMMARY

The present application describes a network interface device bracket. According to an example, the network interface device bracket may be adapted to be removably attached to a network interface device and removably mounted to a mounting surface. The network interface device bracket may include an internal housing that is adapted to connect a jumper cable connected to the network interface device to a drop cable connected to a service provider network and store excess length of the drop cable.

Accordingly, the present disclosure describes a network interface device bracket, comprising: a housing defined by a back plate and at least one sidewall, wherein the back plate comprises a front surface and the at least one sidewall comprises a plurality of interior surfaces; a plurality of attachment openings defined in the back plate for receiving a plurality of fasteners for removably attaching the network interface device bracket to a mounting surface; a cable port defined in the at least one sidewall configured to receive a length of drop cable; a reel included in the housing and defined by outwardly facing sides of one or more raised reel walls extending from the front surface of the back plate configured to provide a core around which a portion of the length of drop cable can be wound and stored; a coupler receptacle configured to receive a coupler adapted to interconnect an end of the drop cable and an end of a jumper cable; and a plurality of forward extending attachment points for removeable attachment of a network interface device to the network interface device bracket.

Additionally, the present disclosure describes a method of interconnecting a network device to a network via a network interface device bracket, comprising: providing a housing comprising a back plate and at least one sidewall, wherein the back place comprises a front surface and a plurality of attachment openings, and the at least one sidewall comprises a plurality of interior surfaces; inserting a plurality of fasteners in the attachment openings to removably attach the network interface device bracket to a mounting surface; inserting a length of drop cable via a cable port; winding a portion of the drop cable around a reel extending from the front surface of the back plate; inserting a coupler into a coupler receptacle of the housing; connecting an end of the drop cable to the coupler; removably attaching a network interface device to the housing via a plurality of forward extending attachment points of the housing; connecting a first end of a jumper cable to the coupler; and connecting a second end of the jumper cable to the network interface device.

Further, the present disclosure describes a network interface device bracket, comprising: a housing defined by a front surface of a back plate and interior surfaces of: a top sidewall; a right sidewall; a bottom sidewall; and a left sidewall; a plurality of attachment openings defined in the back plate for inserting a plurality of fasteners for removably attaching the network interface device bracket to a mounting surface; a cable port defined in the bottom sidewall configured to receive a length of pre-connectorized drop fiber cable; a reel included in the housing and defined by outwardly facing sides of one or more raised reel walls extending from the front surface of the back plate configured to provide a core around which a portion of the length of drop fiber cable can be wound and stored; a coupler receptacle defined in the bottom sidewall configured to hold a coupler adapted to interconnect a connector at an end of the drop fiber cable and a connector at an end of a jumper fiber cable; and a plurality of forward extending attachment points for removeable attachment of a network interface device to the network interface device bracket for securing the network interface device to the mounting surface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example environment that may include a network interface device bracket on which a network interface device may operate according to an example.

FIG. 2 illustrates a front-left isometric view of a network interface device bracket according to an example.

FIG. 3 illustrates a back-right isometric view of the network interface device bracket of FIG. 2 according to an example.

FIG. 4 illustrates a front view of the network interface device bracket of FIG. 2 according to an example.

FIG. 5 illustrates a side view of the network interface device bracket of FIG. 2 according to an example.

FIG. 6 illustrates a back view of the network interface device bracket of FIG. 2 according to an example.

FIG. 7 illustrates a front view of the network interface device bracket of FIG. 2 including a coupler interconnecting a drop cable connector and a jump cable connector according to an example.

FIG. 8 illustrates a front view a network interface device removably coupled to a network interface device bracket attached to a mounting surface according to an example.

FIG. 9 illustrates a back-right isometric view of the network interface device bracket of FIG. 2 coupled to a network interface device according to an example.

FIG. 10 illustrates a bottom isometric view of the network interface device bracket of FIG. 2 with a network interface device removably coupled to the bracket according to an example.

FIG. 11 illustrates a method for providing a network interface device bracket and cable storage according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

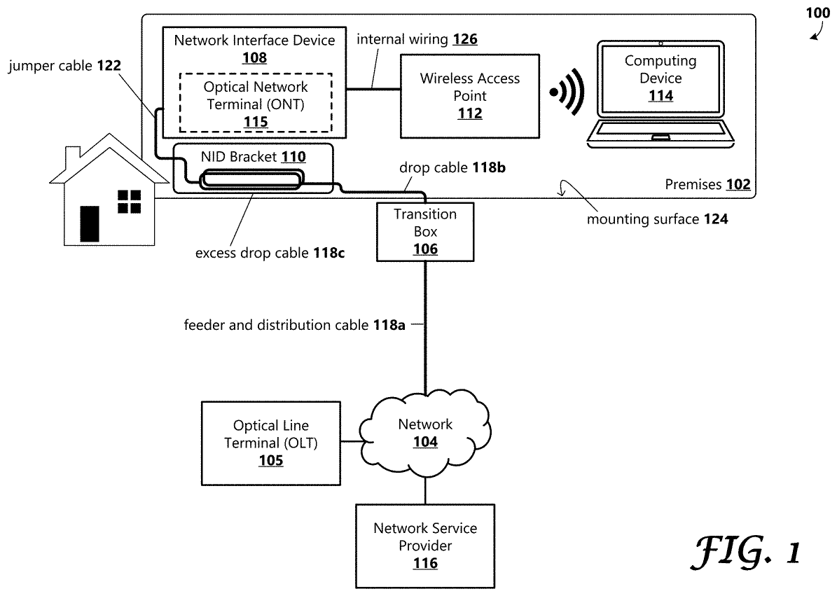

A network interface device bracket and a method of connecting a network device to a network via the network interface device bracket is provided. According to an example, the network interface device bracket may be adapted to be removably attached to the network interface device and removably mounted to a mounting surface. The network interface device bracket may include an internal housing that is adapted to connect a jumper cable connected to the network interface device to a drop cable connected to a service provider network and to store excess length of the drop cable. These and other examples will be explained in more detail below with respect to FIG. 1-FIG. 11.

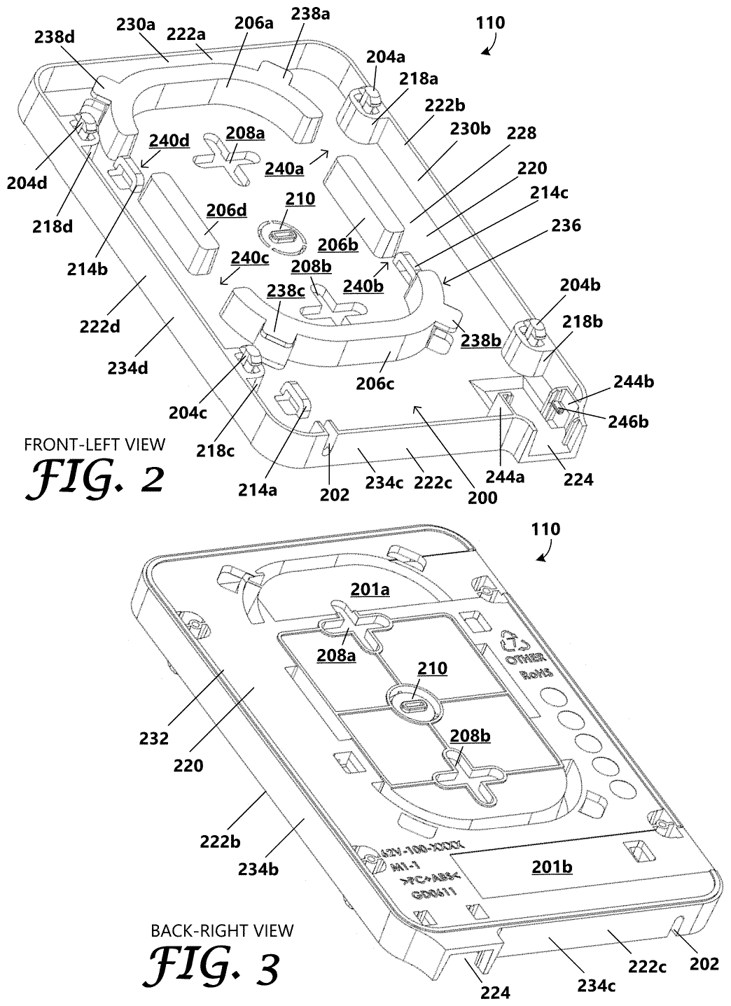

FIG. 1 illustrates an example environment 100 that may include a network interface device (NID) 108, which may be coupled to mount, such as a NID bracket 110 (examples of which are described in detail below with respect to FIGS. 2-10). In some examples, the NID 108 may be provided by or otherwise be associated with a network service provider 116. The network service provider 116 may provide network access, via a network 104 (or combination of networks), to the NID 108. For example, the network service provider 116 may provide wiring/cables 118 that enable a customer to access the network 104 via the NID 108. The NID 108 may serve as an interface between the cables/wiring 118 provided by the network service provider 116 and the wiring on-premises 102, and the NID bracket 110 may generally operate to secure the NID 108 to a mounting surface 124 (e.g., a wall, a low voltage box, a media panel) at a premises 102. The premises 102, for example, may be a home, a multi-dwelling unit, a business, or other location at which network access is desired.

The wiring/cables 118 provided by the network service provider 116 may include fiber-optic cable (sometimes referred to herein as fiber or fiber cable), copper cable, and/or other physical links/circuits that enable customers to access the network 104 via the NID 108. As mentioned above, fiber cable 118 can carry download and upload data at symmetrical high speeds over long distances using pulses of light. With Fiber to the Premises (FTTP) network connectivity, such as shown in the example illustrated in FIG. 1, feed and distribution cable 118a may be run from an optical line terminal (OLT) 105 to a transition box 106, which may be installed outside the premises 102. For instance, the transition box 106 may be used as a termination point for the feeder cable 118a to connect with a first end (not shown) of a drop cable 118b. According to an example, the drop cable 118b may be run from the transition box 106 to the NID bracket 110, on which an optical network terminal (ONT) 115 (e.g., embodied as the NID 108) may be mounted. For example, a fiber network connection may not be able to connect to personal premises equipment (e.g., routers (e.g., wireless access point 112), computing devices 114). Thus, the NID 108 may be a network access device that comprises a combination of a modem and an ONT 115. According to an aspect, the NID bracket 110 may be configured to receive the drop cable 118b, including a second end of the drop cable 118b and, in some examples, excess drop cable 118c. In some examples, the NID bracket 110 may be further configured to store the excess drop cable 118c and interconnect the second end of the drop cable 118b and a first end of a jumper cable 122 that may have a second end received by the NID 108 in a Wide Area Network (WAN) port. In some examples, the NID 108 may be installed exterior to the premises 102. In other examples, the NID 108 may be installed interior to the premises 102. The NID 108, for example, may be configured to transmit data received from the cable 118 to interior wiring (IW) 126 connected to the wireless access point 112 (e.g., a router or gateway), which can then connect to one or more computing devices 114 associated with the premises 102.

When the NID 108 has been coupled to the network 104 (e.g., via a WAN port associated with the NID 108), network access may be provided to the premises 102 via the wireless access point 112. In some examples, the wireless access point 112 may be included in the NID 108. For example, the NID 108 may have both WAN modem capabilities to connect to the network 104 and router capabilities for providing wired and/or wireless network access to one or more computing devices 114 associated with the premises 102. In other examples, the wireless access point 112 may be a device separate from the NID 108, and may operate as a mesh network device, a router or other such network device that provides wired and/or wireless (WI-FI) network access to the one or more computing devices 114. An example NID 108 that can be incorporated in the environment 100 is described in U.S. patent application Ser. No. 17/569,666 titled “SMART NETWORK INTERFACE DEVICE” filed Jan. 6, 2022, the disclosure of which is incorporated by reference herein in its entirety. For example, the NID 108 may operate as an interface between the network 104 provided by the network service provider 116 and one or more wireless access points 112 associated with the premises 102, where the NID 108 may have at least one port (e.g., ethernet port) through which the wireless access point 112 can be communicatively coupled to the NID 108 via internal wiring (IW) 126, such as an ethernet cable.

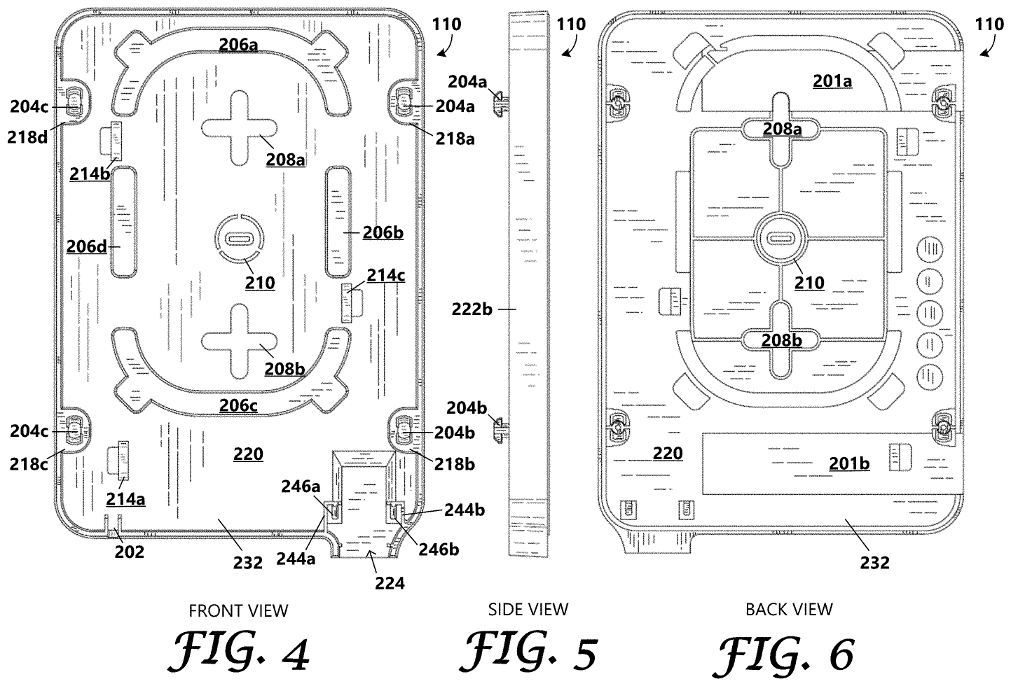

With reference now to FIGS. 2-10, various views of an example NID bracket 110 are illustrated and are described. FIG. 2 illustrates a front-left isometric view, FIG. 3 illustrates a back-right view, FIG. 4 illustrates a front view, FIG. 5 illustrates a right-side view, and FIG. 6 illustrates a back view of the NID bracket 110 according to an example. As shown, the NID bracket 110 may be generally rectangular in shape and may include a back plate 220 having a plurality of sidewalls 222a-d (generally, 222) (e.g., a top sidewall 222a, a right sidewall 222b, a bottom sidewall 222c, and a left sidewall 222d). A front surface 228 of the back plate 220 and interior surfaces 230a-d (generally, 230) of the sidewalls 222 may define an interior housing 200 of the NID bracket 110. A back surface 232 (shown in FIGS. 3 and 6) of the back plate 220 and exterior surfaces 234a-d (generally, 234) of the sidewalls 222 may define the exterior surfaces of the NID bracket 110. The NID bracket 110 may be constructed of various types of materials. In one illustrative example, the NID bracket 110 may be constructed of a polycarbonate or polycarbonate blend material, which, for example, may be shaped into the NID bracket 110 by an injection molding processing method.

In some examples, the NID bracket 110 may include a plurality of device attachment points 204a-d (generally, 204) disposed on the front side of the NID bracket 110 that may be used to removably affix a NID 108 to the NID bracket 110. According to one example and as shown in FIGS. 2 and 4, a plurality of protrusions 218a-d (generally, 218) may protrude inwardly from the interior surfaces 230a-d of the right and left sidewalls 222b, 222d, and each attachment point 204 may extend forwardly from a front-facing surface of the protrusions 218. For example, the attachment points 204 may be aligned with and be shaped to be slidably received by a plurality of slide tracks that may be included in the NID 108. The NID 108 may be removably secured to the NID bracket 110 by sliding the attachment points 204 into the plurality of slide tracks, which may enclose the internal housing 200 of the NID bracket 110. In other examples, a NID 108 may be attached to the NID bracket 110 via another attachment method. In some examples, a lock screw may further be used to further secure the NID 108 to the NID bracket 110.

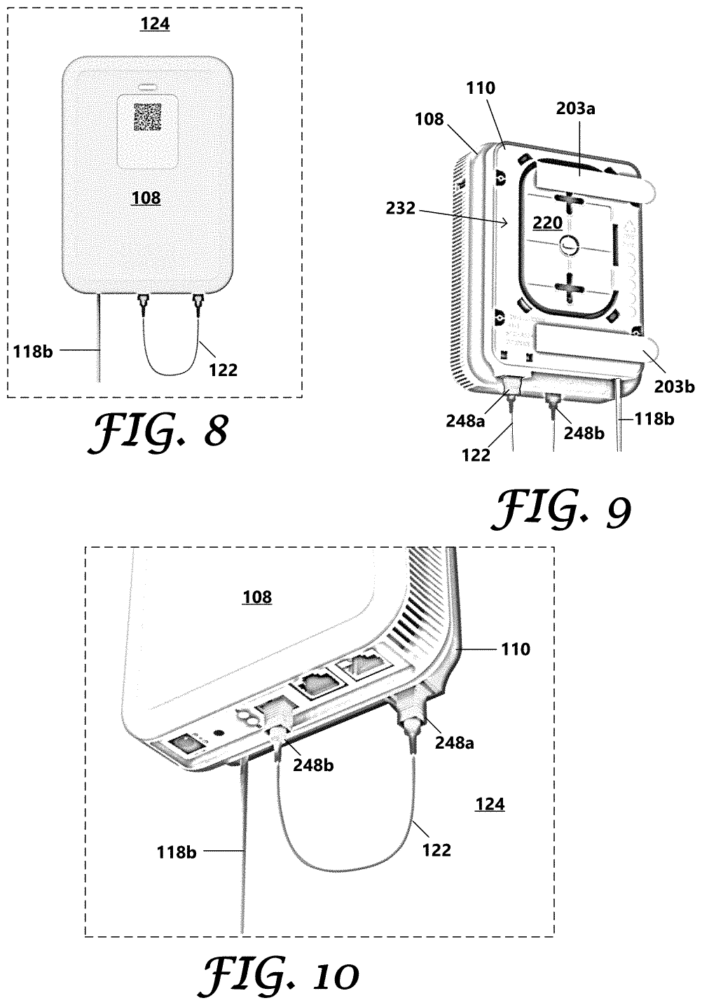

In some examples, a plurality of attachment openings 208a, 208b (generally, 208) may be defined into the back plate 220, through which a fastener (e.g., a screw) may be extended to fasten the NID bracket 110 to a mounting surface 124. According to an example and as shown, the attachment openings 208 may have a cross shape, which may allow for alignment flexibility both horizontally and vertically. As described above, the mounting surface 124 may include a wall, a low voltage box, or a media panel. According to one example, the attachment openings 208a, 208b may be positioned in the back plate 220 such that the attachment openings 208a, 208b may align with attachment openings of a single gang low voltage box or mounting bracket that may be installed in the mounting surface 124. In other examples, other attachment means may be used to attach the NID bracket 110 to the mounting surface 124. For example, and with reference to FIGS. 3, 6, and 9, one or more flat surfaces 201a-b (generally, 201) (shown in FIGS. 3 and 6) may be formed into or otherwise provided on the back surface 232 of the back plate 220, which may be adapted to receive a hook-and-loop fastener 203a,b (generally 203) (shown in FIG. 9), adhesive strip, or other attachment member.

According to another example, a thickness of the back plate 220 and a height of the sidewalls 222 may be sized such that when the NID 108 is attached to the NID bracket 110, the NID 108 and NID bracket 110 may fit within a standard sized media panel enclosure. In an illustrative example, a depth of the NID bracket 110, measured from the back surface 232 to the top of the sidewalls 222, may range from approximately 10-15 mm. In another illustrative example, the depth of the NID bracket 110, measured from the back surface 232 to the top of the sidewalls 222, may be approximately 12.5 mm.

With reference to FIGS. 2, 3, 4, 6, 7, 9, and 10, the NID bracket 110 may define a cable port 202 through which a portion of drop cable 118 may enter/exit the interior housing 200 of the NID bracket 100. In some examples, the cable port 202 may be disposed on the bottom sidewall 222c of the NID bracket 110. In other examples, the cable port 202 may be disposed elsewhere on a surface of NID bracket 110, such as at the top 222a, right 222b, or left sidewalls 222d, or the back plate 220. As described above, the portion of cable 118 may include a portion of drop cable 118b run from the transition box 106 that may be located exterior to the premises 102.

In some implementations, and with reference to FIGS. 2, 3, 4, and 6, a perforation may be formed into the back plate 220, which may define an alternative cable port 210. The perforation may surround an area of the back plate 220, which, when a force is applied to the area, may allow for the area surrounded by the perforation to be easily removed and for the alternative cable port 210 to be exposed. For example, in some cases, the NID bracket 110 may be installed on one side of a mounting surface 124, and the transition box 106, from which the drop fiber 118b entering the NID bracket 110 may be received, may be located on the opposite side of the mounting surface 124 approximately in alignment with the NID bracket 110. Thus, in some examples, the drop fiber 118b exiting the transition box 106 may be routed through a hole in the mounting surface 124 and may be extended through the alternative cable port 210 defined in the back plate 220 of the NID bracket 110.

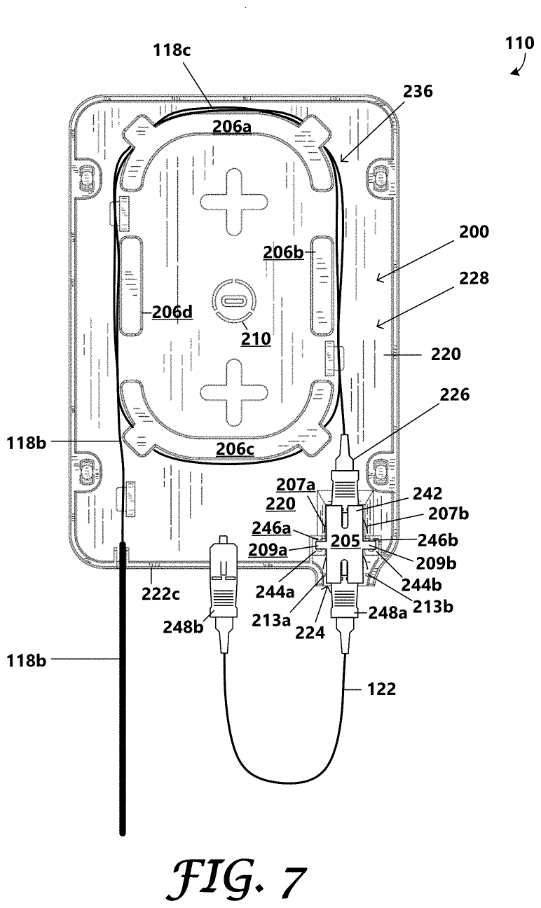

In some examples, the drop cable 118b (a portion of which is shown in FIG. 7) may be pre-connectorized cable. For example, the drop cable 118 may be a pre-measured (e.g., standard) length of cable with connectors 226 attached to each end. The types of connectors 226 may vary. In an illustrative example, the connectors 226 may be angled physical contact (APC) fiber connectors. Pre-connectorized drop cable 118b may offer various advantages, such as installation ease and efficiency and precision and consistency of cable termination, which may ensure that the cable meets standard guidelines and required loss measurements. However, in some cases, when a distance between the transition box 106 and the NID bracket 110 is less than the length of drop cable 118b, a remaining portion of the drop cable (herein referred to as excess drop cable 118c) may be left over. According to an example, the NID bracket 110 may be configured to store excess drop cable 118c in the internal housing 200.

For example, and as shown in FIG. 7, the interior housing 200 may be configured to store a length of cable 118 (e.g., drop cable 118b, excess drop cable 118c) around a reel 236 internal to the housing 200. According to an example, the reel 236 may be defined by the top surface 232 of the back plate 220 and the outwardly facing (e.g., toward the sidewalls 222) sides of one or more raised reel walls 206a-d (generally, 206) extending from the front surface 228 of the back plate 220 and forming a generally elliptical core around which the length of fiber 118 may be wound for storage. In some examples, the reel wall(s) 206 may be configured such that the core formed by the outwardly facing sides of the reel wall(s) 206 may have a radius that is greater than a minimum bend radius of the cable 118. In the examples shown in FIGS. 2 and 4, the NID bracket 110 may include a top reel wall 206a extending forward from a top portion of the front surface 228 of the back plate 220, a right reel wall 206b extending forward from a right-mid portion of the front surface 228, a bottom reel wall 206c extending forward from a bottom portion of the front surface 228, and a left reel wall 206d extending forward from a left-mid portion of the front surface 228. In some examples, the top reel wall 206a and the bottom reel wall 206c may include one or more tabs 238a-d that may generally extend radially outward from a top surface of the top and bottom reel walls 206a, 206c towards the sidewalls 222, which may further define the reel 236 within which the drop cable 118b and/or excess drop cable 118c may be positioned.

In some implementations, and with reference to FIGS. 2, 3, 4, 6, and 7, a perforation may be formed into the back plate 220, which may define an alternative cable port 210 for receiving the drop cable 118b and excess drop cable 118c. The perforation may surround an area of the back plate 220, which, when a force is applied to the area, may allow for the area within the perforation to be easily removed and for the alternative cable port 210 to be opened or exposed. For example, in some cases, the NID bracket 110 may be installed on one side of a mounting surface 124, and the transition box 106, from which the drop cable 118b entering the NID bracket 110 may be received, may be located on the opposite side of a wall and in approximate alignment with the NID bracket 110. Thus, in some examples, the drop cable 118b exiting the transition box 106 may be routed through a hole in and may be extended through the alternative cable port 210 defined in the back plate 220 of the NID bracket 110. In some examples, the reel walls 206 are discontinuous. That is, one or more spaces 240a-d (generally, 240) may be defined between at least two reel walls 206, which, when the drop cable 118b and any excess drop cable 118b is extended through the alternative cable port 210, may provide a channel through which the drop cable 118b can be further routed and wound around the reel 236 defined by the reel walls 206.

In some examples, the NID bracket 110 may further include one or more secure points 214a-c (generally, 214) formed in the front surface 228 of the back plate 220 that may be used to help secure drop cable 118b and any excess drop cable 118b stored in the interior housing 200 of the NID bracket 110. According to an example, each secure point 214 may define an opening through which a cable tie may be extended. For example, the cable tie may be wrapped around the drop cable 118b and/or excess drop cable 118b and an end of the cable tie may be extended through the opening defined in the secure points 214 for securing the drop cable 118b and/or excess drop cable 118b to the NID bracket 110. In some examples, a first secure point 214a may be located between the cable port 202 and the outward facing side of the bottom reel wall 206c, a second secure point 214b may be positioned between the left 206d and top 206a reel walls, and a third secure point 214c may be positioned between the right 206b and bottom 206c reel walls. In one example, the drop cable 118b may be run from the transition box 106, extended through the cable port 202, and routed by and secured to the first secure point 214a. The drop cable 118b may be further routed along the outward facing side of the left reel wall 206d by the second secure point 214b, along the outward facing sides of the top reel wall 206a and right reel wall 206b by the third secure point 214c toward a coupler receptacle 224, where a connector 226 attached to the end of the drop cable 118b may be connected to a coupler 242 (described below with reference to FIG. 7). When the drop cable 118b has been routed past the right reel wall 206b and the third secure point 214c, and when there is excess drop cable 118c left, the excess drop cable 118c may be wrapped, e.g., clockwise around the reel 236 and secured at the second 214b and third 214c attachment points by a cable tie. Or, in another example, the alternative cable port 210 in the back plate 220 may be opened as described above, and the drop cable 118b may be run from the transition box 106, through a wall, and extended through the alternative cable port 210. The drop cable 118b may be further routed through an opening 240 defined between two reel walls 206 (or defined through a reel wall 206) to the reel 236, where the cable (and any excess drop cable 118c) may be wound clockwise around the reel 236 to extend the end of the drop cable 118b to the coupler 242 in the coupler receptacle 224. The drop cable 118b and any excess drop cable 118c may then be secured to the NID bracket 110 via wrapping a cable tie around the cable and securing the cable to the secure points 214.

With reference to FIGS. 2, 4, and 7, in some examples, the NID bracket 110 may include a coupler receptacle 224. For example, the coupler receptacle 224 may be formed into a sidewall 222 and may be shaped and configured to receive and securely hold the coupler 242 mentioned above. According to one example, the coupler receptacle 224 may be formed into the bottom sidewall 222c and may include a pair of sides 244a, 244b. For example, a left side 244a may be configured to receive a first flange 209a of the coupler 242 and a right side 244b may be configured to receive a second flange 209b of the coupler 242. In some examples, a first protrusion 246a may extend from a top wall of the left side 244a, which may engage a first bore defined in the first flange 209a of the coupler 242, and a second protrusion 246b may extend from a top wall of the right side 244b, which may engage a second bore defined in the second flange 209b of the coupler 242. For example, the coupler 242 may be snapped into the coupler receptacle 224, with the pair of flanges 209a, 209b inserted into the pair of sides 244a, 244b and held securely by the protrusions 246 inserted into the bores of the pair of flanges 209a, 209b.

According to some examples, the coupler 242 may interconnect the connector 226 of the drop cable 118b to a first connector 248a at one end of the jumper cable 122, which may connect to the NID 108 via a second connector 248b located at the other end of the jumper cable 122. For example, rather than connecting the drop cable 118b directly to the NID 108, the drop cable 118b may be securely coupled to the coupler 242, which may be securely held in the coupler receptacle 224 included in the NID bracket 110. The jumper cable 122 may be exposed, which may be handled by the customer in various circumstances, such as to troubleshoot the NID 108, remove or replace the NID 108, etc. Thus, if breakage of a cable were to occur due to customer-handling, the breakage may be more likely to occur to the exposed jumper cable 122, which may be a short length (e.g., approximately 6 in.) of cable, and which may be less costly to replace than the more-protected drop cable 118b.

The coupler 242 may be one of various types of couplers. According to an example, the coupler 242 type may correspond with the type of connector 226 included on the drop cable 118 and the type of connector 248a included on the jumper cable 122. In some examples, the coupler 242 may be a Subscription Channel (SC) adapter, and in further examples, the coupler 242 may be an SC-APC adapter. As should be understood, that the scope of the present disclosure is not limited to SC-type or SC-APC-type adapters. The coupler 242, for example, may include a main body 205 with the pair of flanges 209a, 209b located on the exterior of the main body 205. The flanges 209a, 209b may be configured to support the coupler 242 in the coupler receptacle 224.

The coupler 242 may further include a first pair of retaining clips 207a, 207b disposed on the exterior of the main body 205 and positioned between the flanges 209a, 209b and the top end of the coupler 242. In some examples, the coupler 242 may further include a second pair of retaining clips 211a, 211b disposed on the exterior of the main body 205 and positioned between the flanges 209a, 209b and the bottom end of the coupler 242. In some examples, the retaining clips 207a, 207b, 211a, 211b may be metal springs that may be compressed against the main body 205 when inserting the coupler 242 into the coupler receptacle 224, and that may decompress and spring outward when the coupler 242 is seated in the coupler receptacle 224 (with the flanges 209a, 209b inserted into the sides 244a, 244b and with the protrusions 246a, 246b extending into the bores defined in the flanges 209a, 209b). For example, the first pair of retaining clips 207a, 207b may abut top-facing surfaces of the sides 244a, 244b and may provide leverage against a downward pulling force of the coupler 242 (e.g., such as when unplugging the jumper cable 122 from the coupler 242). Additionally, the second pair of retaining clips 211a, 211b may abut top-facing surfaces of a pair of tabs 213a, 213b that may extend into the coupler receptacle 224 from the interior surface of the bottom sidewall 222c, and that may provide leverage against a downward pulling force of the coupler 242.

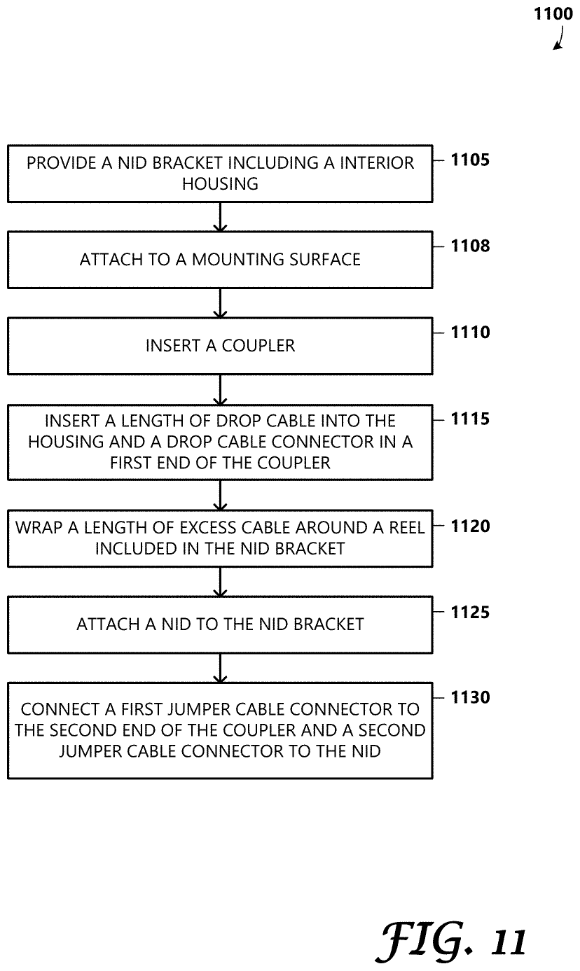

FIG. 11 illustrates a method 1100 for providing a NID bracket 110 that may secure a NID 108 to a mounting surface 124 and connect the NID 108 to a network 104 according to an example. At OPERATION 1105, the NID bracket 110 may be provided. For example, the NID bracket 110 may be formed from a piece of plastic, metal, or other material. In an illustrative example, the NID bracket 110 may be formed into a shape described above and shown in the examples illustrated in FIG. 2-FIG. 10 via injection molding from a polycarbonate or polycarbonate blend material. According to an example, the NID bracket 110 may include a housing 200 defined by the front surface 228 of the back plate 220 and the interior surfaces 230 of a plurality of sidewalls 222 (e.g., the top sidewall 222a, the right sidewall 222b, the bottom sidewall 222c, and the left sidewall 222d). In some examples, the NID bracket 110 may further include a plurality of attachment openings 208 defined in the back plate 220 for inserting a plurality of fasteners for removably attaching the NID bracket 110 to a mounting surface 124. In some examples, the NID bracket 110 may further include the cable port 202 defined in a sidewall configured to receive a length of drop cable 118b. In some examples, the NID bracket 110 may further include a reel 236 defined by outwardly facing sides of one or more raised reel walls 238 extending from the front surface 228 of the back plate 220 configured to provide a core around which a portion of the length of drop cable 118b can be wound and stored. In some examples, the NID bracket 110 may further include the coupler receptacle 224 configured to hold a coupler 242 adapted to interconnect a second end of the drop cable 118b and a first end of a jumper cable 122. In some examples, the NID bracket 110 may further include a plurality of forward extending attachment points 204 for removeable attachment to a NID 108 to the NID bracket 110 for securing the NID 108 to the mounting surface 124, wherein the second end of the jumper cable 122 may be received in a WAN port included in the NID 108. In some examples, the NID bracket 110 may further include one or more other components described above.

At OPERATION 1108, the NID bracket 110 may be attached to a mounting surface 124. In one example, screws or other fasteners may be inserted through the attachment openings 208 defined into the back plate 220. In another example, hook-and-loop fasteners 203 may be attached to flat surfaces 201 formed into the back surface 232 of the back plate 220 and then removably attached to the mounting surface 124.

At OPERATION 1110, a coupler 242 may be inserted into the coupler receptacle 224. For example, the coupler 242 may be inserted into and seated in the coupler receptacle 224, which may include engaging the protrusions 246a, 246b included in the coupler receptacle 224 with the bores defined in the flanges 209a, 209b of the coupler 242. In one example, when inserting the coupler 242, the coupler 242 may be aligned with the coupler receptacle 224 such that the flanges 209a, 209b may be inserted into the coupler receptacle 224 below the protrusions 246a, 246b. This may cause the retaining clips 207a, 207b, 211a, 211b to compress against the main body 205 when pushing the coupler 242 upward toward the protrusions 246a, 246b, until the coupler 242 is seated in the coupler receptacle 224, where the protrusions 246a, 246b may be extended through the bores defined in the flanges 209a, 209b and the retaining clips 207a, 207b, 211a, 211b may be decompressed and spring outward to help secure the coupler 242 from movement when forces may be applied (e.g., when plugging and unplugging cable connectors 226, 248a from the coupler 242).

At OPERATION 1115, a length of drop cable 118b may be run between a transition box 106 and the NID bracket 110, where, in some examples, the first end of the drop cable 118b may be interconnected with the feeder and distribution cable 118a at the transition box 106, and the second end of the drop cable 118b may be inserted into the interior housing 200 of the NID bracket 110. For example, the second end of the drop cable 118b may be inserted into the cable port 202 or alternate cable port 210 and routed around the reel 236 defined in the housing 200 to the coupler 242. The connector 226 attached to the second end of the drop cable 118b may be inserted into the top end of the coupler 242. In some example, if there is an excess length of drop cable 118b, the excess drop cable 118c may be wrapped around the reel 236 at OPERATION 1120. Additionally, one or more cable ties may be inserted through the secure points 214, wrapped around the drop cable 118b and excess drop cable 118c, and fastened.

At OPERATION 1125, a NID 108 may be removably attached to the NID bracket 110. For example, the attachment points 204 extending forward on the front side of the NID bracket 110 may be located and shaped to be slidably received by a plurality of slide tracks that may be included in the NID 108. The NID 108 may be removably secured to the NID bracket 110 by aligning the attachment points 204 with the slide tracks and sliding the attachment points 204 into the plurality of slide tracks.

At OPERATION 1130, a first connector 248a of a jumper cable 122 may be inserted into the bottom end of the coupler 242, which may interconnect the drop cable 118b and jumper cable 122. In some examples, a second connector 248b of the jumper cable 122 may be inserted into the NID 108 in a Wide Area Network (WAN) port. Accordingly, the NID 108 may be connected to the network 104 via the jumper cable 122 connection to the coupler 242 of the NID bracket 110.

The description and illustration of one or more aspects provided in this disclosure are not intended to limit or restrict the scope of the disclosure as claimed in any way. The aspects, examples, and details provided in this disclosure are considered sufficient to convey possession and enable others to make and use the best mode of claimed disclosure. The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A network interface device bracket, comprising:
a housing defined by a back plate and at least one sidewall, wherein the back plate comprises a front surface and the at least one sidewall comprises a plurality of interior surfaces;
a plurality of attachment openings defined in the back plate for receiving a plurality of fasteners for removably attaching the network interface device bracket to a mounting surface;
a cable port defined in the at least one sidewall configured to receive a length of drop cable;
a reel included in the housing and defined by outwardly facing sides of one or more raised reel walls extending from the front surface of the back plate configured to provide a core around which a portion of the length of drop cable can be wound and stored;
a coupler receptacle configured to receive a coupler adapted to interconnect an end of the drop cable and an end of a jumper cable; and
a plurality of forward extending attachment points for removeable attachment of a network interface device to the network interface device bracket.

2. The network interface device bracket of claim 1, wherein the coupler receptacle is configured to hold a coupler adapted to interconnect two angled physical contact (APC) fiber connectors.

3. The network interface device bracket of claim 1, wherein the coupler receptacle comprises:
a left side configured to receive a first flange of the coupler; and
a right side configured to receive a second flange of the coupler.

4. The network interface device bracket of claim 3, wherein:
the left side of the coupler receptacle comprises a first protrusion extending from a top wall of the left side configured to engage a first bore defined in the first flange of the coupler; and
the right side of the coupler receptacle comprises a second protrusion extending from a top wall of the right side configured to engage a second bore defined in the second flange of the coupler.

5. The network interface device bracket of claim 4, wherein the coupler receptacle further comprises a pair of tabs extending into the coupler receptacle from the interior surface of a sidewall configured to abut a pair of retaining clips disposed on sides of an external body of the coupler.

6. The network interface device bracket of claim 1, wherein the one or more raised reel walls comprise a plurality of discontinuous reel walls that are configured to permit the drop cable to be routed between at least two of the reel walls.

7. The network interface device bracket of claim 1, further comprising a perforation formed into the back place defining an alternative cable port through which the length of drop cable can be received, wherein when a force is applied to an area encompassed in the perforation, the alternative cable port is exposed.

8. The network interface device bracket of claim 1, wherein the reel has a radius that is greater than a minimum bend radius of the drop cable.

9. The network interface device bracket of claim 1, further comprising a plurality of secure points extending from the front surface of the back plate and defining an opening through which a cable tie can be extended, wrapped around the drop cable, and fastened.

10. The network interface device bracket of claim 1, further comprising one or more flat surfaces formed into a back surface of the backplate configured to receive one or more hook-and-loop fasteners.

11. The network interface device of claim 1, wherein the plurality of attachment openings is positioned for alignment to attachment openings in a single gang low voltage box.

12. The network interface device of claim 1, wherein the housing and the attached network interface device are configured to fit within a media panel.

13. A method of interconnecting a network device to a network via a network interface device bracket, comprising:
providing a housing comprising a back plate and at least one sidewall, wherein the back place comprises a front surface and a plurality of attachment openings, and the at least one sidewall comprises a plurality of interior surfaces;
inserting a plurality of fasteners in the attachment openings to removably attach the network interface device bracket to a mounting surface;
inserting a length of drop cable via a cable port;
winding a portion of the drop cable around a reel extending from the front surface of the back plate;
inserting a coupler into a coupler receptacle of the housing;
connecting an end of the drop cable to the coupler;
removably attaching a network interface device to the housing via a plurality of forward extending attachment points of the housing;
connecting a first end of a jumper cable to the coupler; and
connecting a second end of the jumper cable to the network interface device.

14. The method of claim 13, further comprising:
inserting a plurality of fasteners for removably attaching the network interface device bracket to one of:
a wall;
a low voltage box; or
a media panel.

15. The method of claim 13, wherein the drop cable and the first end of the jumper cable each terminate in an angled physical contact (APC) fiber connector.

16. The method of claim 13, wherein inserting the coupler into the coupler receptacle comprises:
causing a first protrusion extending from a top wall of a left side of the coupler receptacle to be received into a first bore of the connector; and
causing a second protrusion extending from a top wall of a right side of the coupler receptacle to be received into a second bore of the connector.

17. The method of claim 16, wherein:
the first bore is defined a first flange of the coupler; and
the second bore is defined in a second flange of the coupler.

18. The method of claim 13, further comprising:
fastening the drop cable to the housing by wrapping a cable tie around the drop cable through openings defined in a plurality of secure points in the back plate.

19. A network interface device bracket, comprising:
a housing defined by a front surface of a back plate and interior surfaces of:
a top sidewall;
a right sidewall;
a bottom sidewall; and
a left sidewall;
a plurality of attachment openings defined in the back plate for inserting a plurality of fasteners for removably attaching the network interface device bracket to a mounting surface;
a cable port defined in the bottom sidewall configured to receive a length of pre-connectorized drop fiber cable;
a reel included in the housing and defined by outwardly facing sides of one or more raised reel walls extending from the front surface of the back plate configured to provide a core around which a portion of the length of drop fiber cable can be wound and stored;
a coupler receptacle defined in the bottom sidewall configured to hold a coupler adapted to interconnect a connector at an end of the drop fiber cable and a connector at an end of a jumper fiber cable; and
a plurality of forward extending attachment points for removeable attachment of a network interface device to the network interface device bracket for securing the network interface device to the mounting surface.

20. The network interface device bracket of claim 19, wherein:
the coupler receptacle comprises:
a left side comprising a first protrusion extending from a top wall of the left side configured to engage a first bore defined in the first flange of the coupler;
a right side comprising a second protrusion extending from a top wall of the right side configured to engage a second bore defined in the second flange of the coupler; and
a pair of tabs extending into the coupler receptacle from the interior surface of the bottom sidewall configured to abut a pair of retaining clips disposed on sides of an external body of the coupler.
